(19) United States
(12) Patent Application Publication
(10) Pub. No.: US 2026/0214252 A1
(43) Pub. Date: Jul. 23, 2026

(54) MULTIPLE DESCRIPTION CODING USING NEURAL FIELDS

(71) Applicant: DOLBY LABORATORIES LICENSING CORPORATION, San Francisco, CA (US)

(72) Inventors: Anustup Kumar Atanu CHOUDHURY, Campbell, CA (US); Guan-Ming SU, Fremont, CA (US)

(73) Assignee: DOLBY LABORATORIES LICENSING CORPORATION, San Francisco, CA (US)

(21) Appl. No.: 19/139,009

(22) PCT Filed: Dec. 13, 2023
(86) PCT No.: PCT/US2023/083778

§ 371 Date: Jun. 13, 2025

Related U.S. Application Data
(60) Provisional application No. 63/387,345, filed on Dec. 14, 2022.

(30) Foreign Application Priority Data
Jan. 25, 2023 (EP) 23153357.1

(51) Int. Cl. H04N 19/39; G06N 3/08; H04N 19/154; H04N 19/597

(52) U.S. Cl. CPC H04N 19/39; G06N 3/08; H04N 19/154; H04N 19/597

(57) ABSTRACT

Methods and apparatus for neural-field-based multiple description coding in the source domain and/or coefficient domain. According to an example embodiment, a method for multiple description coding implemented at an electronic decoder comprises receiving, from an electronic encoder, a plurality of descriptions represented by a neural field network. Each of the descriptions is characterized by a respective first set of neural-field-network parameter values obtained via training the neural field network with a multimedia object. Each of the respective first sets of the neural-field-network parameter values corresponds to a different respective sampling of the multimedia object or of a larger second set of neural-field-network parameter values corresponding to the multimedia object. The method further comprises dynamically combining the received descriptions to generate a combined description having a higher quality of representation of the multimedia object than any one of the received descriptions individually.

### 1. CROSS-REFERENCE TO RELATED APPLICATIONS

This application claims the benefit of priority from U.S. Provisional Patent Application Ser. No. 63/387,345, filed on Dec. 14, 2022 and European Patent Application No. EP 23153357.1, filed on 25 Jan. 2023, each of which is incorporated by reference herein in its entirety.

### 2. FIELD OF THE DISCLOSURE

Various example embodiments relate to image processing and, more specifically but not exclusively, to image/video encoding and decoding.

### 3. BACKGROUND

Advances in machine learning have led to the use of methods employing coordinate-based neural networks for solving certain visual-computing problems. Such neural networks, often referred to as “neural fields,” parameterize physical properties of scenes and objects across space and time. Example applications of neural fields include 3D shape and image synthesis, animation of human bodies, and pose estimation. Additional applications of neural fields are currently being actively developed.

### BRIEF SUMMARY OF SOME SPECIFIC EMBODIMENTS

Example embodiments provide a multiple description coding (MDC) framework relying on randomly sampled neural field in the source domain and/or coefficient domain. In a representative example, MDC is directed at providing multiple representations and/or descriptions of the same multimedia content. Each description is decodable individually and provides a relatively coarse level of multimedia quality. When two or more of the descriptions are received, the corresponding MDC decoder operates to merge the received descriptions into a combined description characterized by a higher relative quality of the reconstructed multimedia content than any one of the received descriptions taken individually. Typically, the perceived quality gradually improves as the number of received descriptions increases. In some examples, the number of received descriptions may dynamically change over time. In some deployments, MDC can be used for more-reliable multimedia transport over unstable (e.g., fluctuating) communication links and/or to exploit potential benefits of multipath communication channels.

According to an example embodiment, provided is a method for multiple description coding, comprising: generating, with an electronic encoder, a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and communicating one or more of the plurality of descriptions to an electronic decoder.

According to another example embodiment, provided is an apparatus for multiple description coding, the apparatus comprising: at least one processor; and at least one memory including program code; and wherein the at least one memory and the program code are configured to, with the at least one processor, cause the apparatus at least to: generate a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and direct one or more of the plurality of descriptions via an external communication link.

According to yet another example embodiment, provided is a method for multiple description coding, comprising: receiving, from an electronic encoder, a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and combining, with an electronic decoder, two or more descriptions of the plurality of descriptions to generate a combined description providing a higher quality of representation of the multimedia object than any single description of the plurality of descriptions.

According to yet another example embodiment, provided is an apparatus for multiple description coding, the apparatus comprising: at least one processor; and at least one memory including program code; and wherein the at least one memory and the program code are configured to, with the at least one processor, cause the apparatus at least to: receive a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and combine two or more descriptions of the plurality of descriptions to generate a combined description providing a higher quality of representation of the multimedia object than any one description of the plurality of descriptions.

According to yet another example embodiment, provided is a non-transitory computer-readable medium storing instructions that, when executed by an electronic processor, cause the electronic processor to perform operations comprising a method for multiple description coding, the method comprising: generating, with an electronic encoder, a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and communicating one or more of the plurality of descriptions to an electronic decoder.

According to yet another example embodiment, provided is a non-transitory computer-readable medium storing instructions that, when executed by an electronic processor, cause the electronic processor to perform operations comprising a method for multiple description coding, the method comprising: receiving, from an electronic encoder, a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and combining, with an electronic decoder, two or more descriptions of the plurality of descriptions to generate a combined description providing a higher quality of representation of the multimedia object than any single description of the plurality of descriptions.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 is a block diagram illustrating a multilayer perceptron (MLP) that can be used to implement a neural field according to an embodiment.

FIG. 2 is a block diagram illustrating an MDC encoder according to an embodiment.

FIG. 3 is a block diagram illustrating an MDC decoder according to an embodiment.

FIG. 4 is a block diagram of a communication system for transmission of data from the MDC encoder of FIG. 2 to the MDC decoder of FIG. 3 according to an embodiment.

FIG. 5 graphically illustrates MDC results according to one example.

FIG. 6 graphically illustrates MDC results according to another example.

FIG. 7 graphically illustrates the weights for a description of a 1D object according to one example.

FIG. 8 graphically illustrates a folding operation performed on the weights illustrated in FIG. 7 according to one example.

FIG. 9 is a block diagram illustrating coefficients of a large MLP according to an embodiment.

FIG. 10 is a block diagram illustrating transmitted bits of various MLP coefficients according to one example of MDC in the coefficient domain.

FIG. 11 is a block diagram illustrating a progressive increase of the coefficient information available to the decoder of FIG. 3 with an increasing number of the received descriptions illustrated in FIG. 10.

FIG. 12 graphically illustrates MDC results according to an example of MDC in the coefficient domain.

FIG. 13 is a block diagram illustrating a computing device according to an embodiment.

### DETAILED DESCRIPTION

This disclosure and aspects thereof can be embodied in various forms, including hardware, devices or circuits controlled by computer-implemented methods, computer program products, computer systems and networks, user interfaces, and application programming interfaces; as well as hardware-implemented methods, signal processing circuits, memory arrays, application specific integrated circuits (ASICs), field programmable gate arrays (FPGAs), and the like. The following description is intended solely to give a general idea of various aspects of the present disclosure and does not limit the scope of the disclosure in any way.

In the following description, numerous details are set forth, such as device configurations, timings, operations, and the like, in order to provide an understanding of one or more aspects of the present disclosure. It will be readily apparent to one skilled in the art that these specific details are merely exemplary and not intended to limit the scope of this application.

### Neural Field

Under the neural-field framework, field quantities are produced by sampling coordinates and feeding the sampled coordinates into a neural network. For example, Neural Radiance Field (NeRF) is an implicit 3D scene representation that takes the spatial location (x, y, z) and the viewing direction (θ, φ) as inputs and generates the corresponding predicted color texture and volume density as outputs. The corresponding neural network can be trained, e.g., using a set of 2D images with known camera poses and pertinent intrinsic information. After having been trained, the neural network can be used to render arbitrary views of the 3D scene by (i) querying the corresponding 3D positions and viewing directions for the various pixels in the views and (ii) performing volume rendering to construct a projected 2D image.

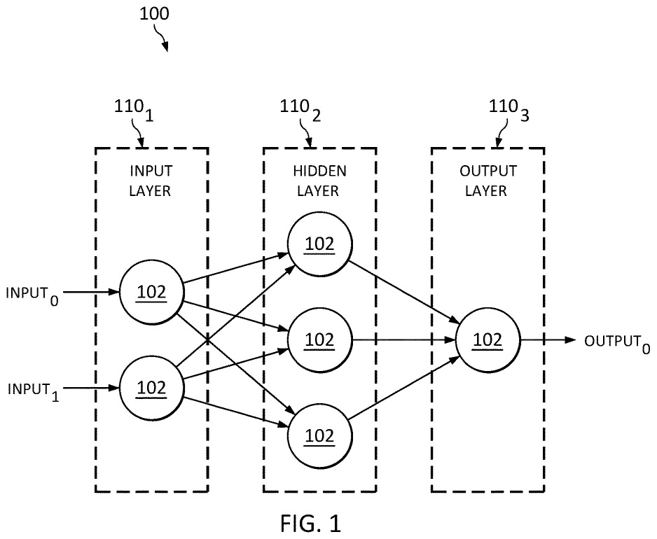

FIG. 1 is a block diagram illustrating a multilayer perceptron (MLP, 100) that can be used to implement a neural field according to an embodiment. In the example shown, the MLP (100) has three layers (110₁-110₃). The first layer (110₁) is an input layer. The next layer (110₂) is a hidden layer. The third layer (110₃) is an output layer. In general, the MLP (100) can have M hidden layers, where M is a positive integer. Thus, the specific example of the MLP (100) illustrated in FIG. 1 corresponds to M=1. In some specific examples, the number M is in the range from 1 to 10.

The MLP (100) is a fully connected feedforward neural network. The “fully connected” attribute means that there is a respective weighted connection between each neural-network (NN) node (also referred to as “processing element,” “neuron,” or “artificial neuron”) from the previous layer to each NN node of the adjacent subsequent layer. An example NN node may scale, sum, and bias the incoming signals and use an activation function to produce an output signal that is a static nonlinear function of the biased sum. Depending on the layer in which a particular NN node is located, the node's output may become either one of the neural network's outputs or be sent to one or more other NN nodes through the corresponding connection(s). The respective weights and/or biases applied by individual NN nodes can be changed (e.g., optimized) during the training (learning) mode of operation and are typically fixed (i.e., constant) during the testing (working) mode of operation. Various embodiments disclosed herein below may employ or rely on one or more neural networks, such as the MLP (100).

An example MLP, such as the MLP (100), uses weights {Wₖ} and biases {bₖ}, where the index k denotes the k-th layer of the MLP. Denoting these parameters as Φ={{Wₖ}, {bₖ}}, one can express the operations performed by the MLP as:

$$\hat{y} = M L {P}_{Φ} ( x ) \qquad ( 1 )$$

where ŷ and x denote the MLP's output and input signals, respectively. With a ground truth signal y^{gt}, the mathematical problem of training the MLP can be formulated as follows:

$${Φ}^{*} = arg {min}_{Φ} D ( {MLP}_{Φ} ( \hat{y} ) , {y}^{gt} ) \qquad ( 2 )$$

where D(,) is the loss function. A lower value of the loss function D(,) implies lower relative distortion, thereby representing better quality of reconstruction.

Since some neural networks, such as the MLP (100), may intrinsically be biased towards preferentially learning lower frequency functions, the inputs thereof may be generated by mapping the initial low-dimensional inputs to a higher dimensional space using a series of trigonometric functions γ for better fitting the output data with high-frequency components. In various examples, the series γ acting on a coordinate p is defined as follows:

$$( 3 )$$

$$γ ( p ) = [ sin ( {2}^{{l}_{0}} πp ) cos ( {2}^{{l}_{0}} πp ) sin ( {2}^{{l}_{1}} πp ) cos ( {2}^{{l}_{1}} πp ) … sin ( {2}^{{l}_{L - 1}} πp ) cos ( {2}^{{l}_{L - 1}} π p ) ]$$

where 2L is the number of trigonometric components of γ; and {l₀, l₁, . . . , lₗ₋₁} are integers. In some examples, lₙ=n.

In the simplified non-limiting example shown in FIG. 1, the layers (110₁, 110₂, 110₃) of the MLP (100) have two, three and one NN nodes (102), respectively. In some other examples, the number of the NN nodes (102) in an MLP layer (110) can be in the range from 1 to 256. Different hidden layers (110) may have different respective numbers of the NN nodes (102) or the same number of the NN nodes (102). In one specific MLP example, in which the above-described positional encoding is used, the input layer has 41 NN nodes (102), and each of five hidden layers has 256 NN nodes (102).

Let us denote the original target multimedia content as Y. Let then p be the number of elements in Y. For example, if Y is a one-dimensional (1D) audio signal (e.g., a digital audio waveform), then p is the number of samples thereof. If Y is a two-dimensional (2D) signal (e.g., a pixelated image), then p is the number of pixels therein. Let Φ_{T} represent the MLP parameters corresponding to the reconstructed multimedia output Ŷ. In the neural field setting, the input to the MLP is the coordinate set X. For a 1D signal, the set X can be a 1D vector containing the sample positions, such as time. For a 2D image, the set X can be a 2D array in which each row contains the pixel positions, such as (x, y) coordinate values. For a three-dimensional (3D) video, the set X can be a 2-D array in which each row contains pixel positions and time, such as (x, y, t). Under this nomenclature, Eq. (1) becomes:

$$\hat{Y} = {MLP}_{{Φ}_{T}} ( X ) \qquad ( 4 )$$

Optimal MLP parameters can be found via a deep learning solver mathematically represented by:

$${Φ}_{T}^{*} = arg {min}_{{Φ}_{T}} D ( {MLP}_{{Φ}_{T}} ( X ) , Y ) \qquad ( 5 )$$

Hereafter, the final compressed neural filed parameter-set size is denoted as |Φ_{T}|.

### Neural Field Multiple Description Coding

Multiple description coding (MDC) is directed at generating N different descriptions, with each of the N descriptions being encoded by a (smaller) neural field with the parameter set Φ_{d}_{ₙ}, where |Φ_{d}_{ₙ}|<|Φ_{T}| for n=0, . . . , N−1, and N is a positive integer greater than one. For such a smaller neural field, Eqs. (4)-(5) become:

$${\hat{Y}}_{n} = {MLP}_{{Φ}_{{d}_{n}}} ( X ) \qquad ( 6 )$$

$${Φ}_{{d}_{n}}^{*} = arg {min}_{{Φ}_{{d}_{n}}} D ( M L {P}_{{Φ}_{{d}_{n}}} ( X ) , Y ) \qquad ( 7 )$$

Since |Φ_{d}_{ₙ}|<|Φ_{T}|, the decoded quality of each individual one of the N descriptions is expected to be lower than that of a single bigger neural network, which can mathematically be expressed by the following inequality:

$$D ( M L {P}_{{Φ}_{T}} * ( X ) , Y ) < D ( {MLP}_{{Φ}_{{d}_{n}}} * ( X ) , Y ) \qquad ( 8 )$$

When an MDC decoder receives k descriptions (denoted as Ωₖ) of the N descriptions (where N≥k), the MDC decoder operates to combine the received descriptions and decode the resulting combined description to produce a higher relative quality of the reconstructed multimedia object(s). The corresponding operations, F, of the MDC decoder can mathematically be expressed as:

$${\hat{Y}}_{{Ω}_{k}} = F ( X , \{ {Φ}_{{d}_{n}} \vert {d}_{n} ∈ {Ω}_{k} \} ) \qquad ( 9 )$$

In general, the quality of the reconstructed multimedia produced by the MDC decoder becomes better as the number of received descriptions increases. This MDC property can be expressed as follows:

$$D ( {\hat{Y}}_{{Ω}_{k 0}} , Y ) < D ( {\hat{Y}}_{{Ω}_{k 1}} , Y ) \qquad ( 10 )$$

where for k0>k1.

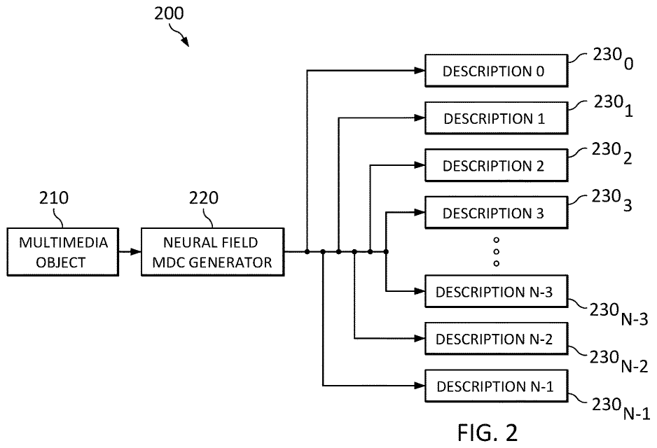

FIG. 2 is a block diagram illustrating a neural-field MDC encoder (200) according to an embodiment. The encoder (200) receives a multimedia object (210) and generates N neural-field-based descriptions (230₀, 230₁, . . . , 230_{N-1}) thereof using a neural field MDC generator (220). In various examples, the multimedia object (210) can be a 1D, 2D, or 3D object, as indicated above. Each of the descriptions (230₀, 230₁, . . . , 230_{N-1}) is represented by a respective instance of the MLP (100). In various embodiments, the different instances of the MLP (100) can be of at least two different sizes or of the same size. Various example functions and features of the MDC generator (220) are described in more detail below.

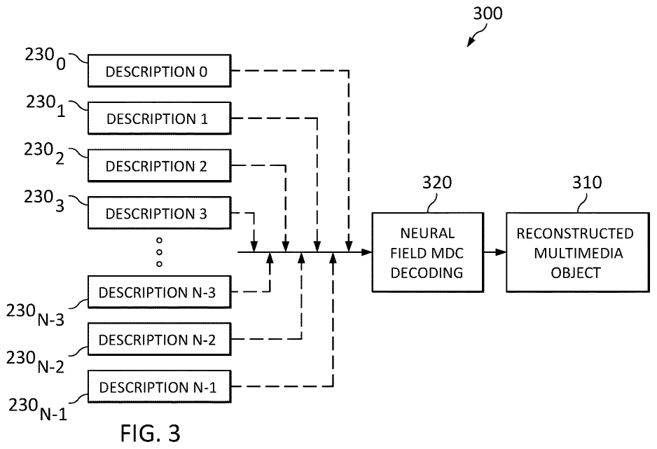

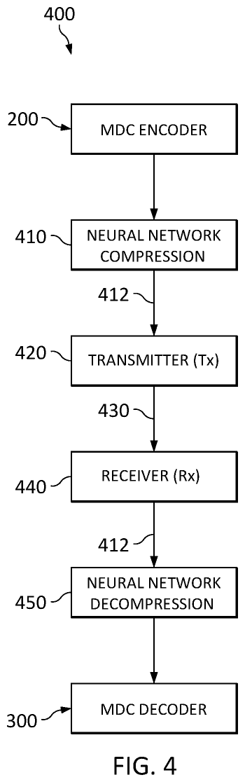

FIG. 3 is a block diagram illustrating a neural-field MDC decoder (300) according to an embodiment. The decoder (300) is configured to receive up to N neural-field-based descriptions (230₀, 230₁, . . . , 230_{N-1}). In various examples, whether the full set of the descriptions (230₀, 230₁, . . . , 230_{N-1}) or a subset thereof is received by the decoder (300) depends on the communication channel between the encoder (200) and the decoder (330), as described in more detail below in reference to FIG. 4. In some examples, the number of the descriptions (230) in the received subset may dynamically change over time, e.g., increase in some time intervals and decrease in some other time intervals. A neural field MDC decoding block (320) of the decoder (300) operates to processes the received (sub)set of the descriptions (230₀, 230₁, . . . , 230_{N-1}) to generate a reconstructed multimedia object (310). The reconstructed multimedia object (300) is typically a close approximation of the source multimedia object (210) based on which the descriptions (230₀, 230₁, . . . , 230_{N-1}) were generated at the encoder (200). The quality of the approximation depends on the number of the descriptions (230) in the received subset and typically improves with an increase of that number. Various example functions and features of the MDC decoding block (320) are described in more detail below.

FIG. 4 is a block diagram of a communication system (400) for transmission of multimedia data from the neural-field MDC encoder (200) to the neural-field MDC decoder (300) according to an embodiment. After the neural-field MDC encoder (200) generates a description (230ₙ), a neural network compression module (410) operates to compress the various neural-network parameters of the corresponding MLP (100) to generate a corresponding neural-network bitstream (412). In different embodiments of the neural network compression module (410), different suitable compression methods can be used. In one specific nonlimiting example, the neural network compression module (410) operates in accordance with the standard for Neural Network Compression and Representation (NNCR), or part 17 of the ISO/IEC 15938 standard, which is incorporated herein by reference in its entirety. The NNCR standard is promulgated by the ISO/IEC Moving Picture Experts Group (MPEG) and specifically targets efficient compression and transmission of neural networks, such as the MLP (100).

A transmitter (420) operates to transform the bitstream (412) into a physical signal suitable for transmission over a communication link (430). In various examples, the communication link (430) can be a wireline, wireless, or optical communication link. A receiver (440) operates to recover the bitstream (412) by processing the physical signal received, via the communication link (430), from the transmitter (420). A neural network decompression module (450) operates to obtain the various neural-network parameters by appropriately decompressing and processing the recovered bitstream (412). The obtained neural-network parameters are then used in the decoder (300) to reconstruct the corresponding MLP (100) in the trained configuration previously computed at the encoder (200).

### Neural Field MDC in the Source Domain

### Uniformly Randomly Sampled Neural Field

An overall example approach described in this subsection includes randomly sampling the pixel locations of the multimedia object (210) for each of the descriptions (230) and building a respective MLP (100) for each of the descriptions (230) at the encoder (200). The parameters of some or all of the MLPs (100) are then transmitted to the decoder (300), e.g., using the communication system (400), as described above in reference to FIG. 4. The decoder (300) operates to generate the reconstructed multimedia object (310) by: reconstructing the MLPs (100) based on the received parameters thereof; computing the corresponding (sub)set of the descriptions (230₀, 230₁, . . . , 230_{N-1}); and then taking an average over the corresponding (sub)set of the descriptions (230₀, 230₁, . . . , 230_{N-1}).

In one example, for each description (230), the encoder (200) operates to select an approximately uniformly distributed random subset of coordinate values from the coordinate set X. This subset is hereafter denoted as X_{d}_{ₙ}. The number of elements in the subset X_{d}_{ₙ} is smaller than the number of elements in the original full set, i.e., |X_{d}_{ₙ}|<|X|. The corresponding set of values in the target signal Y is denoted as Y_{d}_{ₙ}. The training of the corresponding MLP (100) is performed based on X_{d}_{ₙ} and Yd and provides the description (230ₙ), which, based on Eq. (6), can be expressed as:

$${\hat{Y}}_{{d}_{n}} = {MLP}_{{Φ}_{{d}_{n}}} ( {X}_{{d}_{n}} ) \qquad ( 11 )$$

In a representative, the parameters of this MLP (100) are found by solving the following optimization problem:

$${Φ}_{{d}_{n}}^{*} = arg {min}_{{Φ}_{{d}_{n}}} D ( {MLP}_{{Φ}_{{d}_{n}}} ( {X}_{{d}_{n}} ) , {Y}_{{d}_{n}} ) \qquad ( 12 )$$

The encoder (200) generates different ones of the descriptions (230₀, 230₁, . . . , 230_{N-1}) by repeating the above-outlined process with different respective random samplings.

It should be noted that, although the training coordinate set (X_{d}_{ₙ}) is smaller than the full, regular grid coordinate set (X), the corresponding MLP (100) can still learn the values of the full set Y from this (e.g., non-regular/sparse) training coordinate set. The corresponding description (230) is less precise because the corresponding MLP (100) is trained on a subset of the data. However, owing to the MLP's continuity, the decoder (300) can still use this MLP (100) to “approximate” the full original Y.

The corresponding decoder (300) operates to use, for each description (230), the full set of coordinate points, X, as input to the corresponding network

$$M L {P}_{{Φ}_{{d}_{n}}}$$

to generate a predicted signal in accordance with Eq. (13):

$${\hat{Y}}_{n} = {MLP}_{{Φ}_{{d}_{n}}} ( X ) \qquad ( 13 )$$

When the decoder (300) receives more than one description (230), the decoder (300) operates to construct the signal for each of the received descriptions (230) based on Eq. (13). The decoder (300) then operates to compute the final signal (310) by computing the average of the decoded signals from the set Ωₖ of the received descriptions (230) as follows:

$${\hat{Y}}_{{Ω}_{k}} = \frac{1}{k} {\sum }_{{d}_{n} ∈ {Ω}_{k}} {\hat{Y}}_{n} \qquad ( 14 )$$

In various embodiments, the above-indicated processing based on random samplings can be adapted for 1D, 2D, and 3D multimedia objects (210, 310). For example, for 2D multimedia objects (e.g., images), positional encoding may be beneficial for at least some of the reasons already indicated above. In such cases, the neural field is used to predict the red, green, and blue values for every pixel for every image in a sequence of images. The training of the corresponding MLP (100) for the description (230ₙ) is on the coordinate subset of X_{d}_{ₙ}, and the corresponding signal is expressed as follows:

$${\hat{Y}}_{{d}_{n}} = M L {P}_{{Φ}_{{d}_{n}}} ( γ ( {X}_{{d}_{n}} ) ) \qquad ( 15 )$$

where γ is the positional encoding applied on every pixel coordinate X of the image (also see Eq. (3)); and Ŷ=<\hat{R}, Ĝ, \hat{R}> corresponds to the red, green, and blue values of every pixel. The various neural network parameters of the MLP (100) are found by solving the following optimization problem:

$${Φ}_{{d}_{n}}^{*} = arg {min}_{{Φ}_{{d}_{n}}} D ( {\hat{Y}}_{{d}_{n}} , {Y}_{{d}_{n}} ) \qquad ( 16 )$$

where Y_{d}_{ₙ}=<R^{gt}, G^{gt}, B^{gt}> are the red, green, and blue values of the reference (ground truth, or “gt”) image of the sequence. The loss function D represents the overall distortion based on the three (e.g., R, G, B) color channels. In one example, the loss function D is implemented using the Mean-Squared Error (MSE) function. In other examples, other suitable loss functions can similarly be used.

At the decoder (300), for each description (230), the full set of coordinate points, X, is used as input to the small network

$$M L {P}_{{Φ}_{{d}_{n}}}$$

to generate the corresponding predicted signal Ŷₙ as follows:

$${\hat{Y}}_{n} = M L {P}_{{Φ}_{{d}_{n}}} ( γ ( X ) ) \qquad ( 17 )$$

where Ŷ=<\hat{R}, Ĝ, \hat{B}> corresponds to the red, green, and blue values of every pixel. Note that, although the corresponding MLP (100) is trained on a subset of pixels at the encoder (200), the decoder (300) uses that MLP (100) to predict the pixel values of all pixels of the image. The final reconstructed signal (310) is computed as the average of all decoded signals from all received descriptions Ωₖ, i.e.:

$${\hat{Y}}_{{Ω}_{k}} = \frac{1}{k} {\sum }_{{d}_{n} ∈ {Ω}_{k}} {\hat{Y}}_{n} \qquad ( 18 )$$

The different color channels are averaged independently. When written for the individual color channels, Eq. (18) becomes:

$${\hat{R}}_{{Ω}_{k}} = \frac{1}{k} {\sum }_{{d}_{n} ∈ {Ω}_{k}} {\hat{R}}_{n} \qquad ( 19 )$$

$${\hat{G}}_{{Ω}_{k}} = \frac{1}{k} {\sum }_{{d}_{n} ∈ {Ω}_{k}} {\hat{G}}_{n} \qquad ( 20 )$$

$${\hat{B}}_{{Ω}_{k}} = \frac{1}{k} {\sum }_{{d}_{n} ∈ {Ω}_{k}} {\hat{B}}_{n} \qquad ( 21 )$$

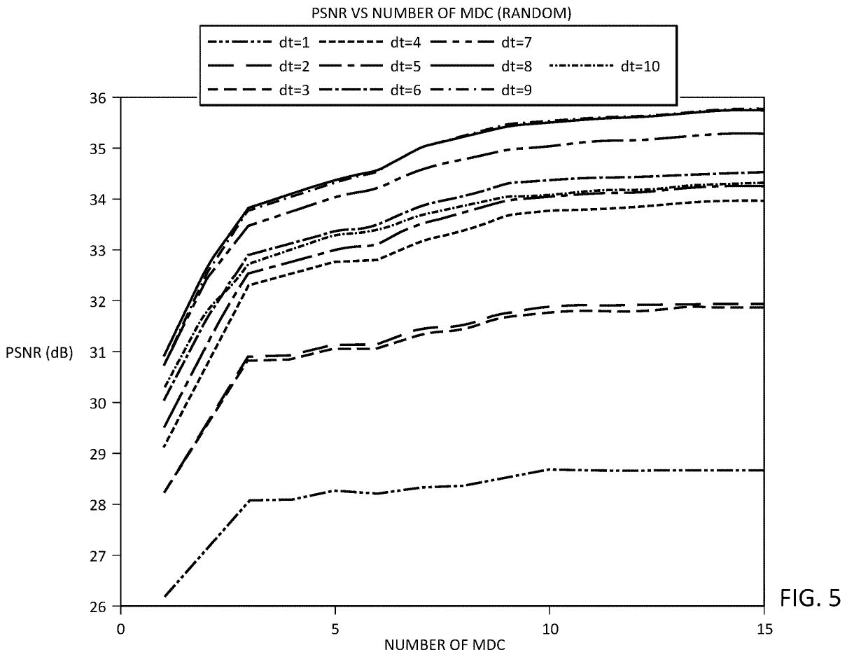

FIG. 5 graphically illustrates MDC results according to one representative example. In this representative example, an image sequence consisting of ten RGB images is processed. The order of the images in the sequence is indicated by the parameter dt. More specifically, for the first image of the image sequence, the parameter dt is dt=1. For the second image of the image sequence, the parameter dt is dt=2, and so on. A large MLP (100) for this image sequence was constructed for reference purposes to judge and compare the observed peak signal-to-noise ratio (PSNR) values. This large MLP (100) had more than 55 thousand (55 k) parameters and was trained on all pixels. For comparison, a smaller MLP (100) for this sequence has about 16 thousand (16 k) parameters (or around 29% of the number of parameters of the large MLP (100)). The total number N of descriptions (230) in this example is N=15. Each of these descriptions (230) is based on a respective smaller MLP (100), with each of the MLPs (100) having been trained using a random set of pixels from the corresponding original image(s) of the image sequence.

The different curves in FIG. 5 correspond to different images of the image sequence, with the corresponding values of the parameter dt being indicated in the legend box. The horizontal axis in FIG. 5 represents the number of descriptions (230) used by the decoder (300) to generate the corresponding reconstructed image sequence (310). The vertical axis in FIG. 5 represents the observed PSNR. The PSNR generally increases as the number of descriptions (230) used by the decoder (300) increases. For each specific number of the used descriptions (230), there is some variation in the PSNR values for different images of the image sequence.

Note that, in the example illustrated in FIG. 5, the encoder (200) has generated exactly fifteen descriptions (230). In other examples, the encoder (200) can be configured to generate more than fifteen, for example twenty, descriptions (230). In such examples, the encoder (200) operates to individually evaluate the full set of twenty descriptions (230) and select therefrom a subset of fifteen best-performing descriptions. The evaluation can be performed, e.g., based on the observed PSNRs displayed by the descriptions when decoded individually, and the fifteen descriptions (230) selected for the subset have the best PSNRs among the full set of twenty descriptions. The fifteen selected descriptions are then transmitted to the decoder (300) over the communication channel (430). This type of MDC typically improves (pushes up at least some portions of) the PSNR curves illustrated in FIG. 5, albeit at the expense of additional processing performed at the encoder (200).

Randomly Sampled Neural Field with Known Sampling Locations

In the examples described in the above subsection, the decoder (300) does not generally have information about the specific pixels that have been used for training the MLP (100) at the encoder (200). In contrast, in the examples described in this subsection, the encoder (200) is configured to send to the decoder (300), with metadata, information identifying the respective set of pixel locations used for training the respective MLP (100) for each description (230). For example, in one configuration, the encoder (200) operates to explicitly specify the pixel locations with the metadata. In another configuration, the encoder (200) operates to send, with the metadata, the seed of a random-number generator used to select the pixel locations for the MLP training process. In a representative example, a seed is a positive integer that initializes the random-number generator (technically, a pseudorandom-number generator) to cause generation of a reproducible stream of pseudorandom numbers. This stream of pseudorandom numbers is used by the encoder (200) to select the pixels for the training process. Upon receiving the seed, the decoder (300) operates to reproduce the stream of pseudorandom numbers, thereby obtaining the information about the pixel locations used by the encoder (200) in the training process.

In a representative example, for each description k, the decoder (300) operates to use the full set of coordinate(s), X, as input to the small network

$${MLP}_{{Φ}_{{d}_{n}}}$$

(100) to generate the corresponding predicted signal in accordance with Eq. (22):

$${\hat{Y}}_{n} = {MLP}_{{Φ}_{{d}_{n}}} ( γ ( X ) ) \qquad ( 22 )$$

where Ŷ=<\hat{R},Ĝ,\hat{B}> corresponds to the red, green, and blue values of every pixel. When the decoder (300) receives more than one description, the decoder (300) is configured to combine those descriptions using a set of combination factors described below.

First, the decoder (300) operates to compute the weighting factor (denoted as w_{d}_{ₙ}(i)) at each pixel (identified by the index i) for each description. For the n-th description (230ₙ), for a pixel with index i that was used for training the corresponding MLP (100) at the encoder (200), the decoder (300) operates to assign a weight of 1 (i.e., w_{d}_{ₙ}(i)=1). For a pixel with index i that was not included in the training process at the encoder (200), for the n-th description (230ₙ), the decoder (300) operates to assign a weight of 0 (i.e., w_{d}_{ₙ}(i)=0).

Among the received k descriptions (230) of the set ωₖ, for each sample point, the decoder (300) operates to calculate the normalization factor as:

$${w}_{{Ω}_{k}} ( i ) = {\sum }_{{d}_{n} ∈ {Ω}_{k}} {w}_{{d}_{n}} ( i ) \qquad ( 23 )$$

When w_{Ω}_{ₖ}(i)>0, the decoder (300) operates to compute the final reconstructed image (310) as the weighted version of all decoded images from all received descriptions Ωₖ, e.g., in accordance with Eq. (24):

$${\hat{Y}}_{{Ω}_{k}} ( i ) = \frac{1}{{w}_{{Ω}_{k}} ( i )} {\sum }_{{d}_{n} ∈ {{Ω}_{k}}^{{w}_{{d}_{n}}}} \cdot {\hat{Y}}_{n} ( i ) if {w}_{{Ω}_{k}} ( i ) > 0 \qquad ( 24 )$$

In some examples, it is possible that some pixels of the image are never selected during the training process at the encoder (200). For those pixels, w_{Ω}_{ₖ}(i)=0, which can cause a divide-by-zero error in the computations corresponding to Eq. (24) at the decoder (300). To avoid such an error for such pixels, the decoder (300) is configured to use the values obtained by averaging the output of all k received descriptions (230). The corresponding conditional operation can mathematically be expressed as:

$${\hat{Y}}_{{Ω}_{k}} ( i ) = \frac{1}{k} {\sum }_{{d}_{n} ∈ {Ω}_{k}} {\hat{Y}}_{n} ( i ) if {w}_{{Ω}_{k}} ( i ) = 0 \qquad ( 25 )$$

The final signal (310) is thus computed by the decoder (300) as follows:

$${\hat{Y}}_{{Ω}_{k}} ( i ) = \frac{1}{{w}_{{Ω}_{k}} ( i )} {\sum }_{{d}_{n} ∈ {Ω}_{k}} {w}_{{d}_{n}} \cdot {\hat{Y}}_{n} ( i ) , when {w}_{{Ω}_{k}} ( i ) > 0 ; \qquad ( 26 - 1 )$$

$${\hat{Y}}_{{Ω}_{k}} ( i ) = \frac{1}{k} {\sum }_{{d}_{n} ∈ {Ω}_{k}} {\hat{Y}}_{n} ( i ) , when {w}_{{Ω}_{k}} ( i ) = 0 \qquad ( 26 - 2 )$$

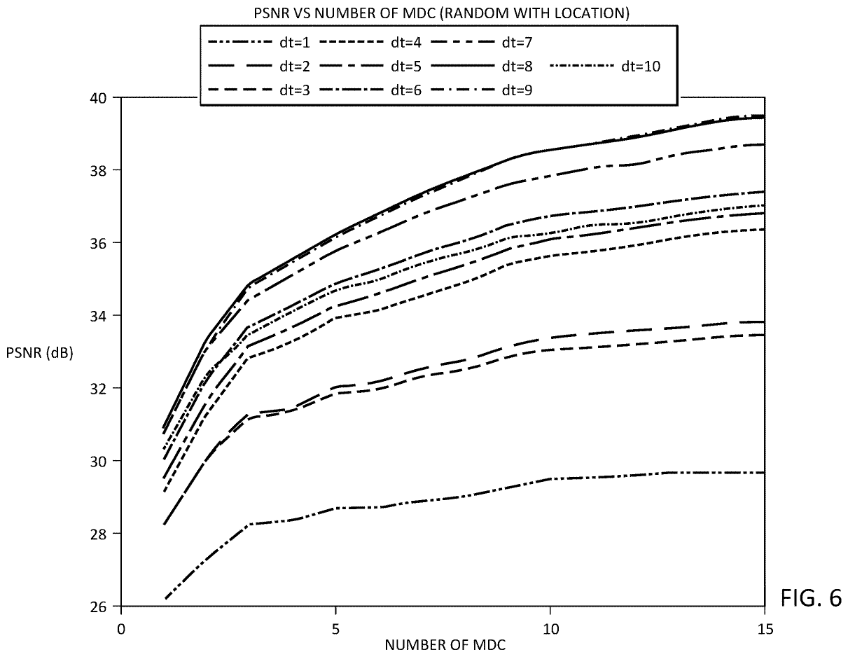

FIG. 6 graphically illustrates MDC results according to a representative example corresponding to the above-described processing (relying on known training pixel locations). In this representative example, the same RGB image sequence as in FIG. 5 is processed. Comparison of the PSNR values shown in FIG. 5 with the PSNR values shown in FIG. 6 indicates an approximate scale of improvements that can be achieved when training-pixel locations are known to the decoder (300). These improvements are achieved at the expense of the corresponding additional processing at the encoder (200) and the decoder (300) and further at the expense of additional communication channel's (430) bandwidth needed for the transmission of the metadata indicating the training-pixel locations.

Additional examples of MDC relying on known training pixel locations can be constructed by modifying the way in which the training pixel locations are selected at the encoder (200) and/or communicated to the decoder (300) over the communication channel (430). In some of such examples, the encoder (200) is configured to select the training pixel locations based on a starting location and a predefined sampling rate. In one example, when the encoder (200) is configured to use 50% of the pixels for training, the encoder (200) may operate to randomly select a starting location and use the sampling frequency that causes every other pixel to be selected. The randomly selected starting location and the the sampling frequency are sent, with metadata, to the decoder (300).

In another additional example, the encoder (200) is configured to use 40% of the pixels for training. Since the pixel locations are typically described by integer values, to select 40% of the pixels, the encoder (200) is configured to use two alternating sampling frequencies. The first of the two sampling frequencies causes the encoder (200) to select every second pixel, whereas the second of the two sampling frequencies causes the encoder (200) to select every third pixel. The randomly selected starting location and the the two sampling frequencies are sent, with metadata, to the decoder (300). In other additional examples, other combinations of sampling frequencies can also be used.

### Non-Uniformly Randomly Sampled Neural Field

Instead of uniform random sampling of the original signal to construct the smaller MLP (100), additional embodiments may rely on a set of descriptions (230), wherein each individual description (230) primarily focuses on a different respective region of interest (ROI) within the image. In such embodiments, the encoder (200) is configured to select a plurality of such ROIs and communicate, with metadata, the pertinent parameters of the selected ROIs to the decoder (300). In various examples, the ROI distribution over the multimedia object (210) can be uniform or non-uniform.

In one example, each ROI (used for a respective one of the descriptions (230)) has sampling points {s} selected based on a Gaussian distribution with the mean value μ_{d}_{ₙ} and the standard deviation value σ_{d}_{ₙ}. For a 1D object (210), the selection can be in accordance with Eq. (27):

$$\{ s \} ∼ N ( {μ}_{{d}_{n}} , {σ}_{{d}_{n}} ) = \frac{1}{{σ}_{{d}_{n}} \sqrt{2 π}} exp ( - \frac{1}{2} {( \frac{s - {μ}_{{d}_{n}}}{{σ}_{{d}_{n}}} )}^{2} ) \qquad ( 27 )$$

The corresponding processing at the encoder (200) can be implemented using the following example processing steps:
Step 1: perform uniform sampling, U, of the interval [0 1] to represent the values of μ_{d}_{ₙ}, wherein

$${μ}_{{d}_{n}} ∼ U ( [ 01 ] ) \qquad ( 28 )$$

Step 2: apply the distribution N(μ_{d}_{ₙ},σ_{d}_{ₙ}) to obtain N_{d}_{ₙ} sampling points. The original number of sampling points is N, wherein N_{d}_{ₙ}<N. The corresponding expression for the sampled coordinate X is as follows:

$${X}_{{d}_{n}} = {\{ {\tilde{x}}_{{d}_{n}} ( i ) \}}_{i = 0}^{{N}_{{d}_{n}} - 1} ∼ N ( {μ}_{{d}_{n}} , {σ}_{{d}_{n}} ) \qquad ( 29 )$$

Step 3: train the corresponding MLP (100) using the N_{d}_{ₙ} sampling points obtained in Step 2. More specifically, the number of elements in the training subset is smaller than in the original full set, i.e., |X_{d}_{ₙ}|<|X|. The corresponding points in the target signal Y are denoted as Y_{d}_{ₙ}. The training of the MLP_{d}_{ₙ} (100) for the corresponding description (230ₙ) is performed based on the corresponding pairs of values extracted from X_{d}_{ₙ} and Y_{d}_{ₙ}. This

$${MLP}_{{Φ}_{{d}_{n}}}$$

(100) is configured to generate the corresponding predicted signal in accordance with Eq. (30):

$${\hat{Y}}_{{d}_{n}} = {MLP}_{{Φ}_{{d}_{n}}} ( {X}_{{d}_{n}} ) \qquad ( 30 )$$

The MLP parameters are found by solving the following optimization problem:

$${Φ}_{{d}_{n}}^{*} = arg {min}_{{Φ}_{{d}_{n}}} D ( {MLP}_{{Φ}_{{d}_{n}}} ( {X}_{{d}_{n}} ) , {Y}_{{d}_{n}} ) \qquad ( 31 )$$

Step 4: transmit the MLP parameters determined in Step 3 along with the metadata containing the parameter values (μ_{d}_{ₙ},σ_{d}_{ₙ}) of the distribution N(μ_{d}_{ₙ},σ_{d}_{ₙ}) to the decoder (300).

For each description (230), the decoder (300) can be configured to use the full set of the coordinate X as input to the network

$${MLP}_{{Φ}_{{d}_{n}}}$$

(100) to generate the corresponding predicted signal as follows:

$${\hat{Y}}_{n} = {MLP}_{{Φ}_{{d}_{n}}} ( X ) \qquad ( 32 )$$

When the decoder (300) receives more than one description (230), the decoder (300) is configured to combine the received descriptions using a set of combination factors described below.

First, the decoder (300) operates to compute the respective weighting factor at each point of each received description (230). Note that, at the encoder (200), the sampling points are taken by applying a modulo operator after the Gaussian distribution with parameters (μ_{d}_{ₙ},σ_{d}_{ₙ}) is drawn. Thus, the decoder (300) operates to reproduce this distribution as weights.

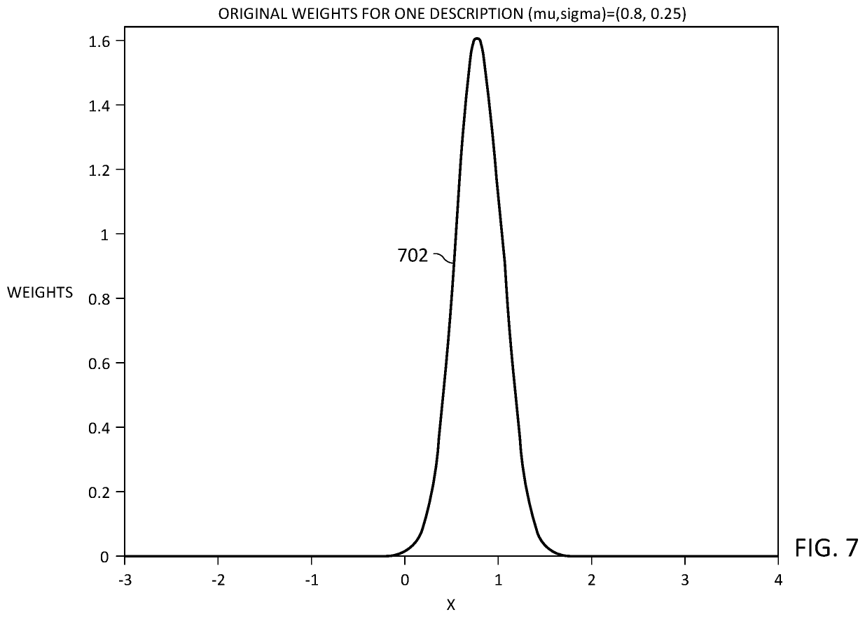

For the n^{th} description (230ₙ), the weights are the normalized circular (modulo) Gaussian distribution calculated based on the values (μ_{d}_{ₙ},σ_{d}_{ₙ}) obtained from the metadata stream. The set of weighting sampling points, x_{w}(k), is computed as

$${x}_{w} ( k ) = {B}_{min} + \frac{k}{N} ,$$

where k=0,1, . . . , N·(Bₘₐₓ−Bₘᵢₙ)−1; and Bₘᵢₙ and Bₘₐₓ are integers. In other words, the decoder (300) performs uniform sampling within the range [Bₘᵢₙ Bₘₐₓ] with the sampling increment of. In some examples, the value of (Bₘᵢₙ, Bₘₐₓ) is (−3, 4), e.g., as illustrated in FIG. 7.

FIG. 7 graphically illustrates the weights computed at the decoder (300) for a 1D description (230ₙ) according to one representative example. More specifically, a curve (702) shown in FIG. 7 represents the weights \tilde{w}_{d}_{ₙ}(k) computed as follows:

$${\tilde{w}}_{{d}_{n}} ( k ) = \frac{1}{{σ}_{{d}_{n}} \sqrt{2 π}} exp ( - \frac{1}{2} {( \frac{{x}_{w} ( k ) - {μ}_{{d}_{n}}}{{σ}_{{d}_{n}}} )}^{2} ) \qquad ( 33 )$$

In this representative example, the distribution parameters μ_{d}_{ₙ}, σ_{d}_{ₙ} have the values (μ_{d}_{ₙ},σ_{d}_{ₙ})=(0.8, 0.25). In other examples, other numerical values of the distribution parameters μ_{d}_{ₙ}, σ_{d}_{ₙ} can also be used.

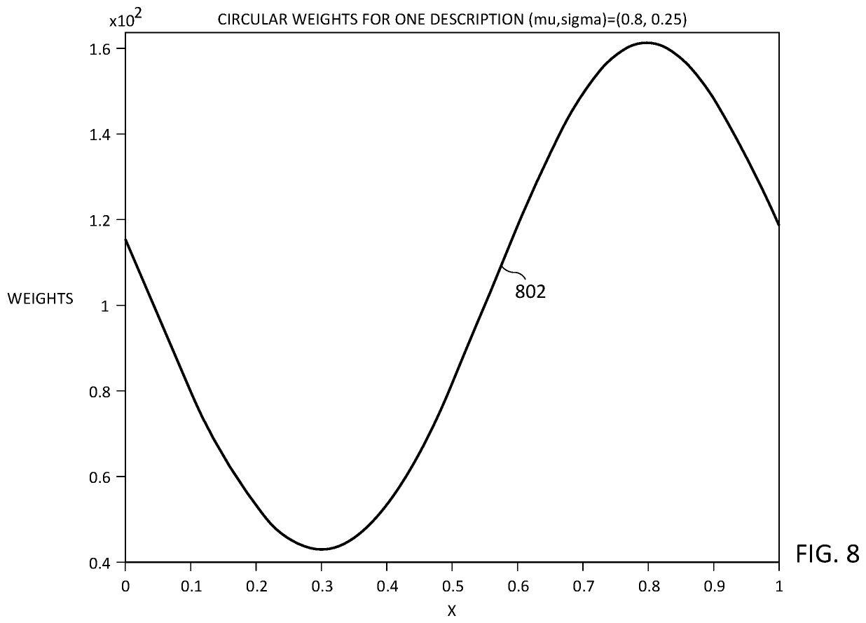

FIG. 8 graphically illustrates a folding operation performed on the weights represented by the curve (702) of FIG. 7 according to one example. Note that the x range in FIG. 7 is [−3, 4], whereas the encoding operation expressed by Eq. (28) is for the interval [0, 1]. The decoder (300) is therefore configured to fold the range [Bₘᵢₙ Bₘₐₓ] into [0 1] by summing up every N points, e.g., as follows:

$${\dot{w}}_{{d}_{n}} ( k ) = {\sum }_{j = 0}^{{B}_{max} - {B}_{min} - 1} {\tilde{w}}_{{d}_{n}} ( k + j N ) \qquad ( 34 )$$

where k=0, 1, . . . , N−1. The decoder (300) then operates to perform normalization of the weights as follows:

$${w}_{{d}_{n}} ( k ) = \frac{{\dot{w}}_{{d}_{n}} ( k )}{{\dot{w}}_{{d}_{n}}} \qquad ( 35 )$$

where

$${\dot{w}}_{{d}_{n}} = {\sum }_{k = 0}^{N - 1} {\dot{w}}_{{d}_{n}} ( k ) .$$

A curve (802) shown in FIG. 8 represents the weights w_{d}_{ₙ}(k) computed using Eq. (35).

Among a set Ωₖ of the k received descriptions (230), for each sample point, the decoder (300) operates to perform further normalization as follows:

$${w}_{{Ω}_{k}} ( k ) = \frac{1}{\vert {Ω}_{k} \vert} {\sum }_{{d}_{n} ∈ {Ω}_{k}} {w}_{{d}_{n}} ( k ) \qquad ( 36 )$$

The final signal (310) is then computed by the decoder (300) as the weighted version of all decoded signals from all received descriptions of the set Ωₖ as follows:

$${\hat{Y}}_{{Ω}_{k}} ( k ) = \frac{1}{k} {\sum }_{{d}_{n} ∈ {Ω}_{k}} {w}_{{Ω}_{k}} ( k ) \cdot {\hat{Y}}_{n} ( k ) \qquad ( 37 )$$

In at least some examples, the process of combining the received descriptions (230) using operations performed in accordance with Eqs. (36)-(37) can beneficially provide better MDC decoding results at the decoder (300) than when the weighting factors w_{Ω}_{ₖ} (k) are computed thereat as

$${w}_{{Ω}_{k}} ( k ) = \frac{1}{\vert {Ω}_{k} \vert} .$$

For a 2D object (210), the selection of sampling points at the encoder (200) can be in accordance with a 2D Gaussian distribution with the mean vector,

$${μ}_{{d}_{n}} = ( {μ}_{{x}_{d n}} , {μ}_{{y}_{d n}} )$$

and the standard deviation vector σ_{d}_{ₙ}=(σ_{xd}_{ₙ},σ_{yd}_{ₙ}). For example, for a 2D image (210), the mean vector is characterized by two coordinates, e.g., along the X and Y coordinate axes. In various examples, the standard deviation values

$${μ}_{{x}_{{d}_{n}}} , {μ}_{{y}_{{d}_{n}}}$$

have the same value or different respective values. Accordingly, for a 2D object (210), the selection of sampling points at the encoder (200) can be in accordance with Eq. (38):

$$\{ s \} ∼ N ( {μ}_{{d}_{n}} , {σ}_{{d}_{n}} ) = \frac{m}{2 \cdot π \cdot {σ}_{x {d}_{n}} \cdot {σ}_{y {d}_{n}}} exp ( - \frac{1}{2} ( \frac{{( x - {μ}_{x {d}_{n}} )}^{2} + {( y - {μ}_{y {d}_{n}} )}^{2}}{{σ}_{x {d}_{n}} \cdot {σ}_{y {d}_{n}}} ) ) \qquad ( 38 )$$

where m is a scalar.

In one example, the corresponding processing at the encoder (200) is implemented using the following processing steps:
Step 1: Perform uniform sampling, U, of the interval [0 1] to represent μ_{yd}_{ₙ} and μ_{xd}_{ₙ} in both the Y and X directions, respectively, wherein:

$${μ}_{x {d}_{n}} ∼ U ( [ 01 ] ) , {μ}_{y {d}_{n}} ∼ U ( [ 01 ] ) \qquad ( 39 )$$

In some cases, the values of the standard deviation vector σ_{d}_{ₙ} can be chosen such that the corresponding area covered by the 2D Gaussian distribution is approximately one quarter of the image.
Step 2: Compute the weights \tilde{w}_{d}_{ₙ}(i) based on the normal distribution N(μ_{d}_{ₙ},σ_{d}_{ₙ}) such that

$${\tilde{w}}_{{d}_{n}} ( i ) ∼ N ( {μ}_{{d}_{n}} , {σ}_{{d}_{n}} ) \qquad ( 40 )$$

Each element of the corresponding weight matrix \tilde{w}_{d}_{ₙ} has a respective value between 0 and 1 for each pixel in the image.
Step 3: Based on a (pseudorandom generator) seed, assign a respective random weight from the interval [0, 1] for each pixel in the image, wherein:

$${\tilde{l}}_{{d}_{n}} ( i ) ∼ U ( [ 01 ] ) \qquad ( 41 )$$

Step 4: Find all pixels in the image for which (ĩ_{d}_{ₙ}(i)−\tilde{w}_{d}_{ₙ}(i))>0.
Step 5: Randomly select N_{d}_{ₙ} points from the points found in Step 4. There are N original sample points, and N_{d}_{ₙ}<N. In some examples, the encoder (200) is configured to select N_{d}_{ₙ}=0.4*N points.
Step 6: Train the corresponding MLP (100) using the N_{d}_{ₙ} sampling points obtained in Step 5. More specifically, the number of elements in the subset

$${X}_{{d}_{n}} = {\{ {x}_{{d}_{n}} ( i ) \}}_{i = {0}^{n}}^{{N}_{d} - 1}$$

is smaller than in the number of elements in the original full set, i.e., |X_{d}_{ₙ}<|X|. The corresponding points in the target signal Y are denoted as Y_{d}_{ₙ}. The training of the

$$M L {P}_{{Φ}_{{d}_{n}}}$$

(100) for the corresponding description (230ₙ) is performed based on the corresponding pairs from X_{d}_{ₙ} and Y_{d}_{ₙ}. This

$$M L {P}_{{Φ}_{{d}_{n}}}$$

(100) is configured to generate the corresponding predicted signal in accordance with Eq. (42):

$${\hat{Y}}_{{d}_{n}} = {MLP}_{{Φ}_{{d}_{n}}} ( γ ( {X}_{{d}_{n}} ) ) \qquad ( 42 )$$

where Ŷ=<\hat{R}, Ĝ, \hat{B}> corresponds to the red, green, and blue values of every pixel; and γ denotes positional encoding. The MLP parameters are found by solving the following optimization problem:

$${Φ}_{{d}_{n}}^{*} = arg {min}_{{Φ}_{{d}_{n}}} D ( {MLP}_{{Φ}_{{d}_{n}}} ( γ ( {X}_{{d}_{n}} ) ) , {Y}_{{d}_{n}} ) \qquad ( 43 )$$

Step 7: Transmit the MLP parameters determined in Step 6 along with the metadata containing the parameters (μ_{d}_{ₙ},σ_{d}_{ₙ}) to the decoder (300).

For each description (230), the decoder (300) can be configured to use the full set of the coordinate X as input to the network

$$M L {P}_{{Φ}_{{d}_{n}}}$$

(100) to generate the corresponding predicted signal as follows:

$${\hat{Y}}_{n} = M L {P}_{{Φ}_{{d}_{n}}} ( γ ( X ) ) \qquad ( 44 )$$

where Ŷ=<\hat{R},Ĝ,\hat{B}> corresponds to the red, green, and blue values of every pixel; and γ denotes positional encoding. When the decoder (300) receives more than one description (230), to combine the received descriptions, the decoder (300) operates to use a set of combination factors described below.

First, the decoder (300) operates to compute the respective weighting factor at each point of each received description (230). Using the Gaussian distribution with parameters (μ_{d}_{ₙ},σ_{d}_{ₙ}) obtained from the metadata stream, the decoder (300) operates to reproduce the distribution used at the encoder (200) as weights, e.g., as follows:

$${w}_{{d}_{n}} ( k ) = \frac{m}{2 \cdot π \cdot {σ}_{x {d}_{n}} \cdot {σ}_{y {d}_{n}}} exp ( - \frac{1}{2} ( \frac{{( x - {μ}_{x {d}_{n}} )}^{2} + {( y - {μ}_{y {d}_{n}} )}^{2}}{{σ}_{x {d}_{n}} \cdot {σ}_{y {d}_{n}}} ) ) \qquad ( 45 )$$

Among the set Ωₖ of received k descriptions (230), for each sample point, the decoder (300) operates to calculate the normalization factor as:

$${w}_{{Ω}_{k}} ( i ) = \frac{1}{\vert {Ω}_{k} \vert} {\sum }_{{d}_{n} ∈ {Ω}_{k}} {w}_{{d}_{n}} ( i ) \qquad ( 46 )$$

The decoder (300) then operates to compute the final image (310) as the weighted version of all decoded images from all received descriptions Ωₖ, e.g., as follows:

$${\hat{Y}}_{{Ω}_{k}} ( i ) = \frac{1}{{w}_{{Ω}_{k}} ( i )} {\sum }_{{d}_{n} ∈ {Ω}_{k}} {w}_{{d}_{n}} ( i ) \cdot {\hat{Y}}_{n} ( i ) if {w}_{{d}_{n}} ( i ) > δ \qquad ( 47 )$$

where δ is a small value representing the threshold of numerical instability. In some examples, it is possible that, for some pixels of the image, w_{Ω}_{ₖ} (i)≤δ, which results in instability of some of the computations corresponding to Eq. (47). To avoid such instability, the decoder (300) is configured to use the values obtained based on averaging the output of all k received descriptions (230). The corresponding conditional operation can mathematically be expressed as:

$${\hat{Y}}_{{Ω}_{k}} ( i ) = \frac{1}{k} {\sum }_{{d}_{n} ∈ {Ω}_{k}} {\hat{Y}}_{n} ( i ) if {w}_{{d}_{n}} ( i ) \leq δ \qquad ( 48 )$$

The final signal (310) is thus computed by the decoder (300) as follows:

$${\hat{Y}}_{{Ω}_{k}} ( i ) = \frac{1}{{w}_{{Ω}_{k}} ( i )} {\sum }_{{d}_{n} ∈ {Ω}_{k}} {w}_{{d}_{n}} ( i ) \cdot {\hat{Y}}_{n} ( i ) , when {w}_{{d}_{n}} ( i ) > δ ; \qquad ( 49 - 1 )$$

$${\hat{Y}}_{{Ω}_{k}} ( i ) = \frac{1}{k} {\sum }_{{d}_{n} ∈ {Ω}_{k}} {\hat{Y}}_{n} ( i ) , when {w}_{{d}_{n}} ( i ) \leq δ \qquad ( 49 - 2 )$$

In various additional embodiments of MDC implementing the Non-Uniformly Randomly Sampled Neural Field, at least some of the following additional or substitute features can be implemented:
(1) Step 4 of the processing implemented at the encoder (200) is modified as follows:
   Step 4: Find all pixels in the image for which (\tilde{w}_{d}_{ₙ}(i)−ĩ_{d}_{ₙ}(i))>0.
This modification tends to increase the probability of finding a pixel in the Gaussian distribution with a higher weight. For some descriptions, an increased value of σ_{d}_{ₙ} may be beneficial when N_{d}_{ₙ}=0.4*N. The corresponding processing at the decoder (300) remains the same as above.
(2) In this feature, Step 4 is modified as in the above-described feature (1). However, in addition to that, instead of randomly choosing the center for a Gaussian, the encoder (200) is configured to place the center of the Gaussian at a selected one of the pre-determined fixed locations, i.e., the values of μ_{d}_{ₙ} correspond to fixed locations. For example, for a 240×100 pixel image, the fifteen predetermined fixed locations can be as follows: (40, 25), (80,25), (120, 25), (160, 25), (200, 25), (40, 50), (80, 50), (120, 50), (160, 50), (200, 50), (40, 75), (80, 75), (120, 75), (160, 75), and (200, 75).
(3) In this feature, Step 4 is modified as in the above-described feature (1). However, in addition to that, the encoder (200) is configured to use an ROI (Region of Interest) instead of a Gaussian distribution. Accordingly, Steps 1 and 2 are replaced by the following operations: (i) calculate the weights based on an ROI. In various examples, the ROI is a rectangle or other suitable shape; (ii) to remove potential boundary artifacts due to the ROI, blur the boundary of the ROI, e.g., of the rectangle; (iii) a most important portion of the image is given the highest weight, and other portions are given lower weights. Let us denote this weight as \tilde{w}_{d}_{ₙ}. The weight matrix \tilde{w}_{d}_{ₙ} has values between 0 and 1 for all the pixels in the image. In addition, instead of sending the Gaussian kernel parameters as metadata, parameter(s) pertaining to the ROI and the blur kernel are treated as metadata and associated with each description. An example set of parameters for an ROI can be in the form of a list of pertinent coordinates for a well-defined shape or a segmentation mask. Likewise, the parameter(s) pertaining to the blur kernel can be the kernel size and the sigma. Transmitted as metadata to the decoder (300), these parameters are used as weighting factors for combining multiple descriptions (230) together.
(4) Other additional features may include keeping Step 1 unchanged at the encoder (200) and then combining the features (2) and (3), i.e., using the Gaussian kernels at predetermined fixed locations and using ROIs instead of the Gaussian distributions.

### Neural Field MDC in the Coefficient Domain

In some additional examples, neural field MDC is implemented in the neural network coefficient domain. More specifically, using a large MLP (100) that provides high multimedia reconstruction quality, the encoder (200) can be configured to randomly select some coefficients in full precision and quantize the rest of the coefficients to lower precision, e.g., a smaller number (such as one, in some examples) of most significant bits (MSBs). The resulting MLP (100) has a smaller model size than the initial large MLP (100) but is still capable of providing an acceptable description (230). A corresponding embodiment of the encoder (200) is configured to construct a plurality of such MLPs (100) to obtain a corresponding plurality of descriptions (230). A corresponding embodiment of the decoder (300) is configured to generate the reconstructed multimedia object (310) by combining the received descriptions (230) so constructed by the encoder (200).

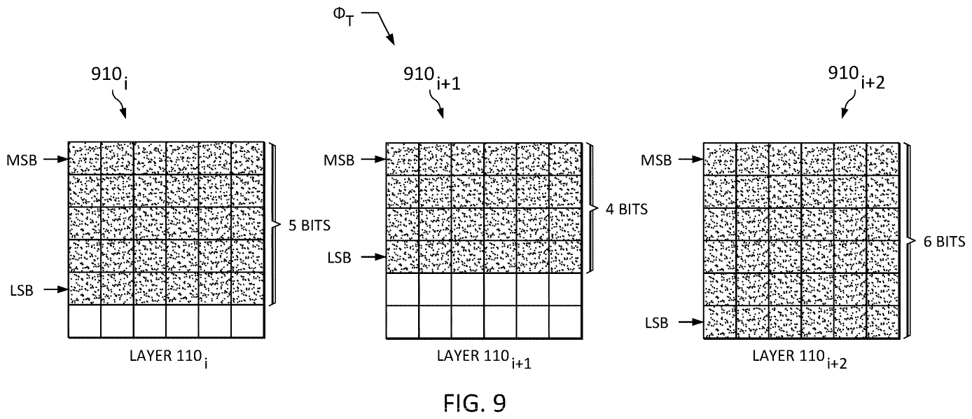

FIG. 9 is a block diagram illustrating coefficients of a large MLP (100) according to an embodiment. Recall that Φ_{T} represents the set of parameters of the large MLP (100) (e.g., see Eq. (4)). For illustration purposes and without any implied limitations, FIG. 9 shows a subset of the set Φ_{T} corresponding to only three layers of the large MLP (100), i.e., the layers (110ᵢ, 110ᵢ₊₁, 110ᵢ₊₂). The NN coefficients of each layer (110) are represented by a respective bit block (910), wherein each column represents a respective one of the coefficients. In general, the coefficients cᵢ can be vectorized across each layer such that the corresponding vectors cᵢ represent both weights and biases of the NN nodes.

For the layer (110₁), each of the coefficients has five bits, with the MSBs of the coefficients being in the first row of the bit block (910ᵢ), and the least significant bits (LSBs) of the coefficients being in the fifth row of the bit block (9101). The sixth row of the bit block (910ᵢ) is empty. For the layer (110ᵢ₊₁), each of the coefficients has four bits, with the MSBs of the coefficients being in the first row of the bit block (910ᵢ₊₁), and the LSBs of the coefficients being in the fourth row of the bit block (910ᵢ₊₁). The fifth and sixth rows of the bit block (910ᵢ₊₁) are empty. For the layer (110ᵢ₊₂), each of the coefficients has six bits, with the MSBs of the coefficients being in the first row of the bit block (910ᵢ₊₂), and the LSBs of the coefficients being in the sixth row of the bit block (910ᵢ₊₂). Hereafter, mi denotes the smaller number of MSBs used for some coefficients in MDC. For illustration purposes and without any implied limitations, further examples described below correspond to mᵢ=1. In other examples, a different value of mᵢ can also be used, wherein such different value is smaller than the full length of the bit-words representing the coefficients ci.

Let us denote the set of all coefficient indices as ψ. For each description (dₙ) (230), the encoder (200) is configured to select a random seed (rₙ) for the pseudorandom number generator RNG( ) to randomly generate values in the interval [0 1] for each coefficient. A fixed threshold, tₙ, is used to determine whether to set the coefficient to full precision or to MSB only. Let us denote the selected full-precision coefficient indices as a set

$${ψ}_{{d}_{n}}^{f} .$$

The encoder (200) operates to transmit those coefficients at the original precision (cᵢ). Let us further denote the rest of the coefficients as a set

$${ψ}_{{d}_{n}}^{m} = ψ ∖ {ψ}_{{d}_{n}}^{f} .$$

The encoder (200) operates to transmit the latter coefficients as MSBs (mᵢ). The encoder (200) decides on the length of the ii transmitted coefficient based on the following equation:

$$( R N {G}_{{r}_{n}} ( i ) ) < {t}_{n} ? {c}_{i} : {m}_{i} \qquad ( 50 )$$

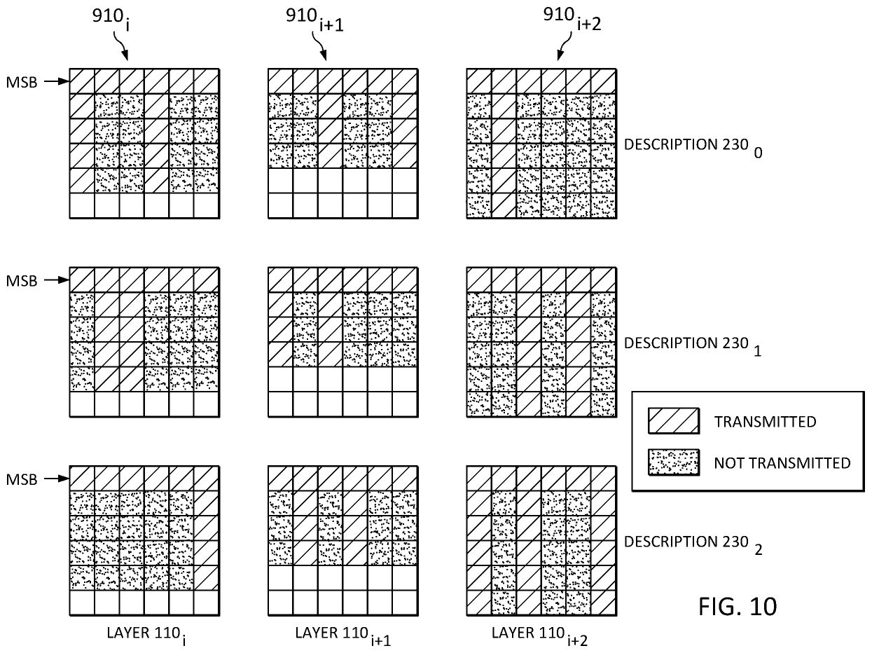

FIG. 10 is a block diagram illustrating the sets

$${ψ}_{{d}_{n}}^{f} and {ψ}_{{d}_{n}}^{m}$$

for three example descriptions (230₀, 230₁, 230₂). For the description (230₀), in the bit block (910ᵢ), two coefficients (represented by the first and fourth columns) belong to the set

$${ψ}_{{d}_{n}}^{f}$$

and are transmitted at full precision. The remaining four coefficients belong to the set

$${ψ}_{{d}_{n}}^{m}$$

and are transmitted as MSBs. In the bit block (910ᵢ₊₁), two coefficients (represented by the third and sixth columns) belong to the set

$${ψ}_{{d}_{n}}^{f}$$

and are transmitted at full precision. The remaining four coefficients belong to the set

$${ψ}_{{d}_{n}}^{m}$$

and are transmitted as MSBs. In the bit block (910ᵢ₊₂), one coefficient (represented by the second column) belongs to the set

$${ψ}_{{d}_{n}}^{f}$$

and is transmitted at full precision. The remaining five coefficients belong to the set

$${ψ}_{{d}_{n}}^{m}$$

and are transmitted as MSBs.

For the description (230₁), in the bit block (910ᵢ), two coefficients (represented by the second and third columns) belong to the set

$${ψ}_{{d}_{n}}^{f}$$

and are transmitted at full precision. The remaining four coefficients belong to the set

$${ψ}_{{d}_{n}}^{m}$$

and are transmitted as MSBs. In the bit block (910ᵢ₊₁), two coefficients (represented by the first and third columns) belong to the set

$${ψ}_{{d}_{n}}^{f}$$

and are transmitted at full precision. The remaining four coefficients belong to the set

$${ψ}_{{d}_{n}}^{m}$$

and are transmitted as MSBs. In the bit block (910ᵢ₊₂), two coefficients (represented by the third and fifth columns) belong to the set

$${ψ}_{{d}_{n}}^{f}$$

and are transmitted at full precision. The remaining four coefficients belong to the set

$${ψ}_{{d}_{n}}^{m}$$

and are transmitted as MSBs.

For the description (230₂), in the bit block (910ᵢ), one coefficient (represented by the sixth column) belongs to the set

$${ψ}_{{d}_{n}}^{f}$$

and is transmitted at full precision. The remaining five coefficients belong to the set

$${ψ}_{{d}_{n}}^{m}$$

and are transmitted as MSBs. In the bit block (910ᵢ₊₁), two coefficients (represented by the second and fourth columns) belong to the set

$${ψ}_{{d}_{n}}^{f}$$

and are transmitted at full precision. The remaining four coefficients belong to the set

$${ψ}_{{d}_{n}}^{m}$$

and are transmitted as MSBs. In the bit block (910ᵢ₊₂), three coefficients (represented by the first, third, and sixth columns) belong to the set

$${ψ}_{{d}_{n}}^{f}$$

and are transmitted at full precision. The remaining three coefficients belong to the set

$${ψ}_{{d}_{n}}^{m}$$

and are transmitted as MSBs.

The encoder (200) further operates to transmit the seed (rₙ) and the threshold (tₙ) to the decoder (300) with metadata. Based on the received metadata, the decoder (300) operates to determine the contents of the sets

$$( {ψ}_{{d}_{n}}^{f} and {ψ}_{{d}_{n}}^{m} )$$

using the same random number generator RNG ( ) that has been used at the encoder (200). Among the received k descriptions set Ωₖ, the decoder (300) can collect the coefficients with full precisions from all descriptions (230), e.g., based on the following expression:

$${\tilde{ψ}}_{{d}_{n}}^{f} = {⋃}_{{d}_{n} ∈ {Ω}_{k}} {ψ}_{{d}_{n}}^{f} \qquad ( 51 )$$

The MSB-only coefficients will be in the rest of positions, e.g., as mathematically expressed by:

$${\tilde{ψ}}_{{d}_{n}}^{m} = ψ ∖ {\tilde{ψ}}_{{d}_{n}}^{f} \qquad ( 52 )$$

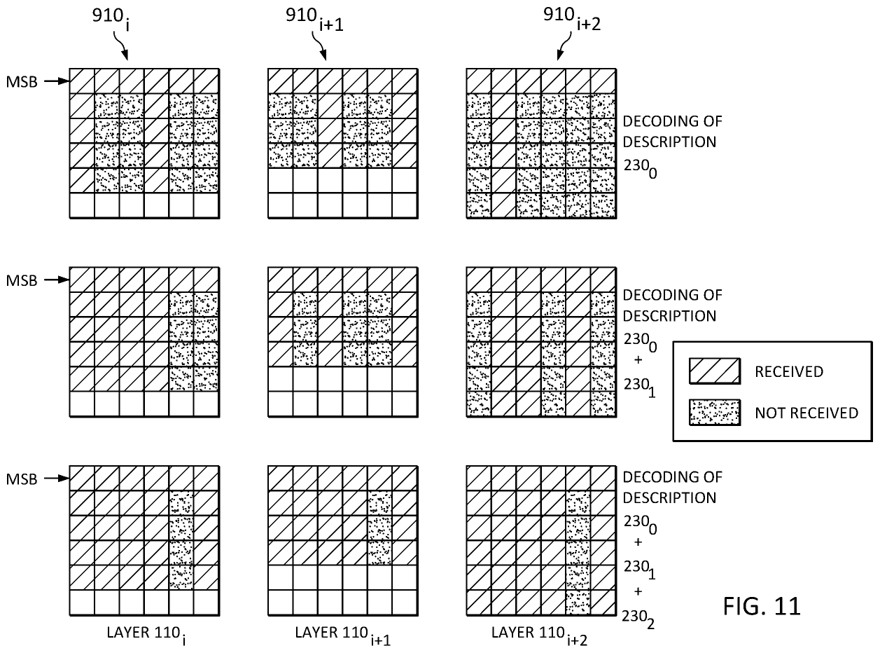

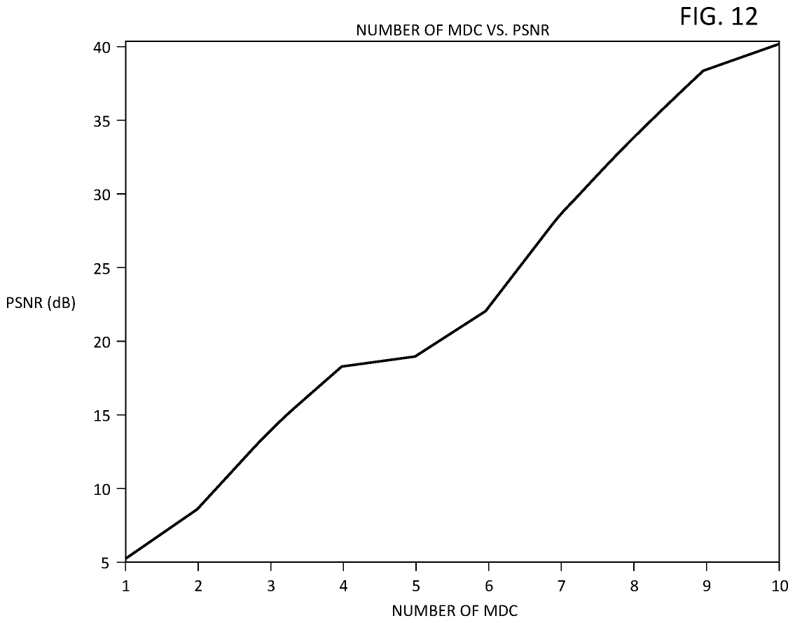

FIG. 11 is a block diagram illustrating a progressive increase of the MLP coefficient information available to the decoder (300) with the increase of the received number of descriptions (230) for the example descriptions (230₀, 230₁, 230₂) illustrated in FIG. 10. The top row of the bit blocks (910ᵢ, 910ᵢ₊₁, 910ᵢ₊₂) in FIG. 11 shows the coefficient information available to the decoder (300) when only the description (230₀) is received from the encoder (200). The middle row of the bit blocks (910ᵢ, 910ᵢ₊₁, 910ᵢ₊₂) in FIG. 11 shows the coefficient information available to the decoder (300) when the descriptions (230₀, 230₁) are received from the encoder (200). Note a relative increase in the number of “received” bits in the middle row of the bit blocks (910ᵢ, 910ᵢ₊₁, 910ᵢ₊₂) compared to the top row. The bottom row of the bit blocks (910ᵢ, 910ᵢ₊₁, 910ᵢ₊₂) in FIG. 11 shows the coefficient information available to the decoder (300) when the descriptions (230₀, 230₁, 230₂) are received from the encoder (200). Note a relative increase in the number of “received” bits in the bottom row of the bit blocks (910ᵢ, 910ᵢ₊₁, 910ᵢ₊₂) compared to the middle row. The increased amount of the received coefficient information typically results in the commensurate increase in the quality of the reconstructed multimedia object (310), e.g., as graphically illustrated by the results shown FIG. 12.

FIG. 12 graphically illustrates MDC results according to an example of MDC in the coefficient domain. In this example, the multimedia object (210) is a 1D waveform. The horizontal axis in FIG. 12 represents the number of descriptions (230) used by the decoder (300) to generate the corresponding reconstructed multimedia object (310). The vertical axis in FIG. 12 represents the observed PSNR. The PSNR generally increases as the number of the descriptions (230) used by the decoder (300) increases.

### Hybrid Neural Field MDC

Herein, the term “Hybrid Neural Field MDC” refers to embodiments that incorporate features of both Neural Field MDC in the Source Domain and Neural Field MDC in the Coefficient Domain described above. In one of such embodiments, the neural field MDC can be implemented using a random subset of image samples for training the corresponding MLP (100) in accordance with the source-domain MDC and then selection/quantization of the transmitted coefficients in accordance with the coefficient-domain MDC. This approach can be used, e.g., for creating a hierarchical MDC model. For example, the encoder (200) may create five descriptions (230) by applying source-domain MDC. Then, for each of those five descriptions (230), the encoder (200) may create 3 or 4 sub-descriptions with the coefficient-domain MDC. As a result, the encoder (200) may thereby create 15 or 20 different descriptions (230), which provides additional combination options to the corresponding decoder (300).

### Example Hardware

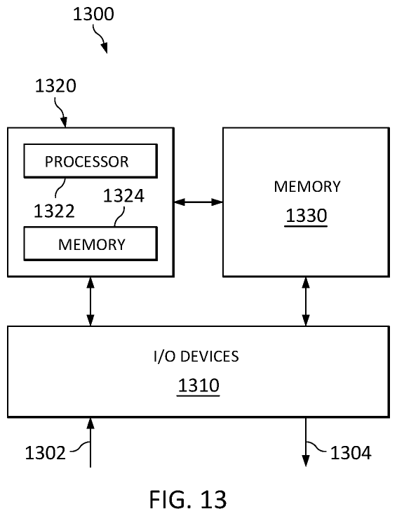

FIG. 13 is a block diagram illustrating a computing device (1300) according to an embodiment. The device (1300) can be used, e.g., to implement the encoder (200) or the decoder (300). The computing device (1300) comprises input/output (I/O) devices (1310), a processing engine (1320), and a memory (1330). The I/O devices (1310) may be used to enable the device (1300) to receive various input signals (1302) and to output various output signals (1304). For example, when the computing device (1300) implements the encoder (200), the input signals (1302) include the object (210), whereas the output signals (1304) include the descriptions (230) and corresponding metadata (when applicable). When the computing device (1300) implements the decoder (300), the input signals (1302) include the received descriptions (230) and corresponding metadata (if any), whereas the output signals (1304) include the reconstructed object (310).

The memory (1330) may have buffers to receive object data and/or other pertinent data. Once the data are received, the memory (1330) may provide parts of the data to the processing engine (1320) for processing therein. The processing engine (1320) includes a processor (1322) and a memory (1324). The memory (1324) may store therein program code, which when executed by the processor (1322) enables the processing engine (1320) to perform data processing, including but not limited to MDC. The program code may include, inter alia, the program code used to emulate the various neural networks, e.g., the MLP (100) described above.

According to an example embodiment disclosed above, e.g., in the summary section and/or in reference to any one or any combination of some or all of FIGS. 1-13, provided is an apparatus for multiple description coding, the apparatus comprising: at least one processor; and at least one memory including program code; and wherein the at least one memory and the program code are configured to, with the at least one processor, cause the apparatus at least to: generate a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and direct one or more of the plurality of descriptions via an external communication link.

According to another example embodiment disclosed above, e.g., in the summary section and/or in reference to any one or any combination of some or all of FIGS. 1-13, provided is a method for multiple description coding, comprising: generating, with an electronic encoder, a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and communicating one or more of the plurality of descriptions to an electronic decoder.

In some embodiments of the above method, the multimedia object is an audio waveform, an image, a sequence of images, a spatial audio, or a video.

In some embodiments of any of the above methods, the video comprises a 3-dimensional video or a volumetric video.

In some embodiments of any of the above methods, the image comprises a volumetric image.

In some embodiments of any of the above methods, the communicating comprises communicating two or more of the plurality of descriptions to the electronic decoder.

In some embodiments of any of the above methods, any two or more descriptions of the plurality of descriptions are combinable to generate a combined description.

In some embodiments of any of the above methods, the combined description provides a higher quality of representation of the multimedia object than any single description of the plurality of descriptions.

In some embodiments of any of the above methods, the method further comprises selecting, with the electronic encoder, the different respective subsets of the sampled coordinate values using a pseudorandom number generator.

In some embodiments of any of the above methods, the method further comprises communicating a seed used by the pseudorandom number generator to the electronic decoder with a metadata stream.

In some embodiments of any of the above methods, the method further comprises communicating the different respective subset of the sampled coordinate values to the electronic decoder with a metadata stream.

In some embodiments of any of the above methods, the method further comprises selecting, with the electronic encoder, the different respective subsets of the sampled coordinate values of the multimedia object using a different respective Gaussian distributions.

In some embodiments of any of the above methods, the method further comprises communicating mean and standard-deviation values of the different respective Gaussian distributions to the electronic decoder with a metadata stream.

In some embodiments of any of the above methods, the respective first set of neural-field-network parameter values comprises: a respective first subset of the larger second set of neural-field-network parameter values at full precision; and a respective second subset of the larger second set of neural-field-network parameter values at less than full precision.

In some embodiments of any of the above methods, each of the respective first sets of the neural-field-network parameter values corresponds to a different respective subset of sampled coordinate values of the multimedia object and a different respective sampling of the larger second set of neural-field-network parameter values.

In some embodiments of any of the above methods, the plurality of descriptions comprises a first number of descriptions; wherein the method further comprises selecting a second number of descriptions from the first number of descriptions, the second number being a positive integer greater than one and smaller than the first number; and wherein the communicating comprises communicating the second number of descriptions to the electronic decoder.

In some embodiments of any of the above methods, the selecting comprises: computing a respective quality-metric value for each of the first number of descriptions; and ranking the first number of descriptions in a descending order of the respective quality-metric values; and wherein the second number of descriptions includes the second number of top-ranked descriptions according to the ranking.

In some embodiments of any of the above methods, the respective quality-metric values are peak signal-to-noise ratio values.

According to yet another example embodiment disclosed above, e.g., in the summary section and/or in reference to any one or any combination of some or all of FIGS. 1-13, provided is an apparatus for multiple description coding, the apparatus comprising: at least one processor; and at least one memory including program code; and wherein the at least one memory and the program code are configured to, with the at least one processor, cause the apparatus at least to: receive a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and combine one or more of the plurality of descriptions to generate a combined description having a higher quality of representation of the multimedia object than any one description of the plurality of descriptions.

According to yet another example embodiment disclosed above, e.g., in the summary section and/or in reference to any one or any combination of some or all of FIGS. 1-13, provided is a method for multiple description coding, comprising: receiving, from an electronic encoder, a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and combining, with an electronic decoder, two or more descriptions of the plurality of descriptions to generate a combined description having a higher quality of representation of the multimedia object than any single description of the plurality of descriptions.

In some embodiments of the above method, the multimedia object is an audio waveform, an image, a sequence of images, a spatial audio, or a video.

In some embodiments of any of the above methods, the method further comprises receiving, with a metadata stream, a seed used by a pseudorandom number generator to select the different respective subset of the sampled coordinate values at the electronic encoder.

In some embodiments of any of the above methods, the method further comprises receiving, with a metadata stream, the different respective subset of the sampled coordinate values.

In some embodiments of any of the above methods, the method further comprises receiving, with a metadata stream, mean and standard-deviation values of different respective Gaussian distributions used to select the different respective different respective subsets of the sampled coordinate values of the multimedia object at the electronic encoder.

In some embodiments of any of the above methods, the respective first set of neural-field-network parameter values comprises: a respective first subset of the larger second set of neural-field-network parameter values at full precision; and a respective second subset of the larger second set of neural-field-network parameter values at less than full precision.

In some embodiments of any of the above methods, each of the respective first sets of the neural-field-network parameter values corresponds to a different respective sampling of the multimedia object and a different respective subset of sampled coordinate values of the larger second set of neural-field-network parameter values.

In some embodiments of any of the above methods, the combining comprises: for each of the two or more descriptions, generating a respective reconstructed multimedia object by inputting a full set of coordinate values into the description; and combining the respective reconstructed multimedia objects corresponding to the two or more descriptions to generate a combined reconstructed multimedia object.

In some embodiments of any of the above methods, the combining the respective reconstructed multimedia objects comprises, for each element of the combined reconstructed multimedia object, computing a respective weighted sum of corresponding elements of the respective reconstructed multimedia objects.

In some embodiments of any of the above methods, for a first element of the combined reconstructed multimedia object, the respective weighted sum is an average of the corresponding elements of all of the respective reconstructed multimedia objects; and wherein, for a second element of the combined reconstructed multimedia object, the respective weighted sum is an average of the corresponding elements of fewer than all of the respective reconstructed multimedia objects.

In some embodiments of any of the above methods, the first element has a coordinate value that is not present in any of the different respective subsets of sampled coordinate values; and wherein the second element has a coordinate value that is present in at least one but in fewer than all of the different respective subsets of sampled coordinate values.

According to yet another example embodiment disclosed above, e.g., in the summary section and/or in reference to any one or any combination of some or all of FIGS. 1-13, provided is a non-transitory computer-readable medium storing instructions that, when executed by an electronic processor, cause the electronic processor to perform operations comprising a method for multiple description coding, the method comprising: generating, with an electronic encoder, a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and communicating one or more of the plurality of descriptions to an electronic decoder.

According to yet another example embodiment disclosed above, e.g., in the summary section and/or in reference to any one or any combination of some or all of FIGS. 1-13, provided is a non-transitory computer-readable medium storing instructions that, when executed by an electronic processor, cause the electronic processor to perform operations comprising a method for multiple description coding, the method comprising: receiving, from an electronic encoder, a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and combining, with an electronic decoder, two or more of the plurality of descriptions to generate a combined description having a higher quality of representation of the multimedia object than any single description of the plurality of descriptions.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented invention(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented invention(s). When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term compatible means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

“BRIEF SUMMARY OF SOME SPECIFIC EMBODIMENTS” in this specification is intended to introduce some example embodiments, with additional embodiments being described in “DETAILED DESCRIPTION” and/or in reference to one or more drawings. “BRIEF SUMMARY OF SOME SPECIFIC EMBODIMENTS” is not intended to identify essential elements or features of the claimed subject matter, nor is it intended to limit the scope of the claimed subject matter.

Various aspects of the present invention may be appreciated from the following enumerated example embodiments (EEEs):

EEE 1. A method for multiple description coding, comprising:
generating, with an electronic encoder, a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and
communicating one or more of the plurality of descriptions to an electronic decoder.

EEE 2. The method of EEE 1, wherein the multimedia object is an audio waveform, an image, a sequence of images, a spatial audio, or a video.

EEE 3. The method of EEE 2, wherein the video comprises a 3-dimensional video or a volumetric video.

EEE 4. The method of EEE 2, wherein the image comprises a volumetric image.

EEE 5. The method of any one of EEE 1-EEE 4, wherein the communicating comprises communicating two or more of the plurality of descriptions to the electronic decoder.

EEE 6. The method of EEE 5, wherein any two or more descriptions of the plurality of descriptions are combinable to generate a combined description.

EEE 7. The method of EEE 6, wherein the combined description provides a higher quality of representation of the multimedia object than any single description of the plurality of descriptions.

EEE 8. The method of any one of EEE 1-EEE 7, further comprising selecting, with the electronic encoder, the different respective subset of the sampled coordinate values using a pseudorandom number generator.

EEE 9. The method of EEE 8, further comprising communicating a seed used by the pseudorandom number generator to the electronic decoder with a metadata stream.

EEE 10. The method of any one of EEE 1-EEE 9, further comprising communicating the different respective subset of the sampled coordinate values to the electronic decoder with a metadata stream.

EEE 11. The method of any one of EEE 1-EEE 10, further comprising selecting, with the electronic encoder, the different respective subsets of the sampled coordinate values of the multimedia object using different respective Gaussian distributions.

EEE 12. The method of EEE 11, further comprising communicating mean and standard-deviation values of the different respective Gaussian distributions to the electronic decoder with a metadata stream.

EEE 13. The method of any one of EEE 1-EEE 12, wherein the respective first set of neural-field-network parameter values comprises:
a respective first subset of the larger second set of neural-field-network parameter values at full precision; and
a respective second subset of the larger second set of neural-field-network parameter values at less than full precision.

EEE 14. The method of any one of EEE 1-EEE 13, wherein each of the respective first sets of the neural-field-network parameter values corresponds to a different respective subset of sampled coordinate values of the multimedia object and a different respective sampling of the larger second set of neural-field-network parameter values.

EEE 15. The method of any one of EEE 1-EEE 14,
wherein the plurality of descriptions comprises a first number of descriptions;
wherein the method further comprises selecting a second number of descriptions from the first number of descriptions, the second number being a positive integer greater than one and smaller than the first number; and
wherein the communicating comprises communicating the second number of descriptions to the electronic decoder.

EEE 16. The method of EEE 15,
wherein the selecting comprises:
   computing a respective quality-metric value for each of the first number of descriptions; and
   ranking the first number of descriptions in a descending order of the respective quality-metric values; and
wherein the second number of descriptions includes the second number of top-ranked descriptions according to the ranking.

EEE 17. The method of EEE 16, wherein the respective quality-metric values are peak signal-to-noise ratio values.

EEE 18. A non-transitory computer-readable medium storing instructions that, when executed by an electronic processor, cause the electronic processor to perform operations comprising a method of any one of EEE 1-EEE 17.

EEE 19. An apparatus for multiple description coding, the apparatus comprising:
at least one processor; and
at least one memory including program code; and
wherein the at least one memory and the program code are configured to, with the at least one processor, cause the apparatus at least to:
   generate a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and
   direct one or more of the plurality of descriptions via an external communication link.

EEE 20. A method for multiple description coding, comprising:
receiving, from an electronic encoder, a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and
combining, with an electronic decoder, two or more descriptions of the plurality of descriptions to generate a combined description providing a higher quality of representation of the multimedia object than any single description of the plurality of descriptions.

EEE 21. The method of EEE 20, wherein the multimedia object is an audio waveform, an image, a sequence of images, a spatial audio, or a video.

EEE 22. The method of EEE 20 or EEE 21, further comprising receiving, with a metadata stream, a seed used by a pseudorandom number generator to select the different respective subset of the sampled coordinate values at the electronic encoder.

EEE 23. The method of any one of EEE 20-EEE 22, further comprising receiving, with a metadata stream, the different respective subset of the sampled coordinate values.

EEE 24. The method of any one of EEE 20-EEE 23, further comprising receiving, with a metadata stream, mean and standard-deviation values of different respective Gaussian distributions used to select the different respective subsets of the sampled coordinate values of the multimedia object at the electronic encoder.

EEE 25. The method of any one of EEE 20-EEE 24, wherein the respective first set of neural-field-network parameter values comprises:
a respective first subset of the larger second set of neural-field-network parameter values at full precision; and
a respective second subset of the larger second set of neural-field-network parameter values at less than full precision.

EEE 26. The method of any one of EEE 20-EEE 25, wherein each of the respective first sets of the neural-field-network parameter values corresponds to a different respective subset of sampled coordinate values of the multimedia object and a different respective sampling of the larger second set of neural-field-network parameter values.

EEE 27. The method of any one of EEE 20-EEE 26, wherein the combining comprises:
for each of the two or more descriptions, generating a respective reconstructed multimedia object by inputting a full set of coordinate values into the description; and
combining the respective reconstructed multimedia objects corresponding to the two or more descriptions to generate a combined reconstructed multimedia object.

EEE 28. The method of EEE 27, wherein the combining the respective reconstructed multimedia objects comprises, for each element of the combined reconstructed multimedia object, computing a respective weighted sum of corresponding elements of the respective reconstructed multimedia objects.

EEE 29. The method of EEE 28,
wherein, for a first element of the combined reconstructed multimedia object, the respective weighted sum is an average of the corresponding elements of all of the respective reconstructed multimedia objects; and
wherein, for a second element of the combined reconstructed multimedia object, the respective weighted sum is an average of the corresponding elements of fewer than all of the respective reconstructed multimedia objects.

EEE 30. The method of EEE 29,
wherein the first element has a coordinate value that is not present in any of the different respective subsets of sampled coordinate values; and
wherein the second element has a coordinate value that is present in at least one but in fewer than all of the different respective subsets of sampled coordinate values.

EEE 31. A non-transitory computer-readable medium storing instructions that, when executed by an electronic processor, cause the electronic processor to perform operations comprising a method of any one of EEE 20-EEE 30.

EEE 32. An apparatus for multiple description coding, the apparatus comprising:
at least one processor; and
at least one memory including program code; and
wherein the at least one memory and the program code are configured to, with the at least one processor, cause the apparatus at least to:
   receive a plurality of descriptions represented by a neural field network, each of the plurality of descriptions being characterized by a respective first set of neural-field-network parameter values obtained via training the neural field network with a multimedia object, each of the respective first sets of the neural-field-network parameter values corresponding to a different respective subset of sampled coordinate values of the multimedia object or of a larger second set of neural-field-network parameter values corresponding to the multimedia object; and
   combine two or more descriptions of the plurality of descriptions to generate a combined description providing a higher quality of representation of the multimedia object than any one description of the plurality of descriptions.

EEE 33. A computer-readable storage medium comprising instructions that, when executed by an electronic processor, cause the electronic processor to perform the method of any one of EEE 1-EEE 17.

EEE 34. A computer program product comprising instructions that, when executed by an electronic processor, cause the electronic processor to perform the method of any one of EEE 1-EEE 17.

EEE 35. An apparatus for multiple description coding, the apparatus comprising at least one processor, wherein the at least one processor is configured to perform the method of any one of EEE 1-EEE 17.

EEE 36. A computer-readable storage medium comprising instructions that, when executed by an electronic processor, cause the electronic processor to perform the method of any one of EEE 20-EEE 30.

EEE 37. A computer program product comprising instructions that, when executed by an electronic processor, cause the electronic processor to perform the method of any one of EEE 20-EEE 30.

EEE 38. An apparatus for multiple description coding, the apparatus comprising at least one processor, wherein the at least one processor is configured to perform the method of any one of EEE 20-EEE 30.

1. A method for multiple description coding, comprising:
generating, with an electronic encoder, a plurality of descriptions using a neural network implementing a neural field, each of the plurality of descriptions comprising a respective first set of neural network parameter values obtained via training a respective instance of the neural network with a different respective subset of a set of sampled coordinate values of a multimedia object or of a larger second set of neural network parameter values corresponding to the multimedia object, wherein any two or more descriptions of the plurality of descriptions are combinable to generate a reconstruction of the multimedia object; and
communicating two or more of the plurality of descriptions to an electronic decoder.

2. The method of claim 1, wherein the multimedia object is an audio waveform, an image, a sequence of images, a spatial audio, a 2-dimensional video, or a volumetric video.

3-4. (canceled)

5. The method of claim 1, wherein the combined description provides a higher quality of reconstruction of the multimedia object than any single description of the plurality of descriptions.

6. The method of claim 1, further comprising:
selecting, with the electronic encoder, the different respective subset of the set of sampled coordinate values using a pseudorandom number generator and communicating a seed used by the pseudorandom number generator to the electronic decoder with a metadata stream.

7. (canceled)

8. The method of claim 1, further comprising communicating the different respective subset of the set of sampled coordinate values to the electronic decoder with a metadata stream.

9. The method of claim 1, further comprising:
selecting, with the electronic encoder, the different respective subsets of the set of sampled coordinate values of the multimedia object using different respective Gaussian distributions.

10. The method of claim 9, further comprising communicating mean and standard-deviation values of the different respective Gaussian distributions to the electronic decoder with a metadata stream.

11. The method of claim 1, wherein the respective first set of neural network parameter values comprises:
a respective first subset of the larger second set of neural network parameter values at full precision; and
a respective second subset of the larger second set of neural network parameter values at less than full precision.

12. The method of claim 1, wherein each of the respective first sets of the neural network parameter values corresponds to a different respective subset of the set of sampled coordinate values of the multimedia object and a different respective sampling of the larger second set of neural network parameter values.

13. The method of claim 1,
wherein the plurality of descriptions comprises a first number of descriptions;
wherein the method further comprises selecting a second number of descriptions from the first number of descriptions, the second number being a positive integer greater than one and smaller than the first number; and
wherein the communicating comprises communicating the second number of descriptions to the electronic decoder.

14. The method of claim 13,
wherein the selecting comprises:
computing a respective quality-metric value for each of the first number of descriptions; and
ranking the first number of descriptions in a descending order of the respective quality-metric values; and
wherein the second number of descriptions includes the second number of top-ranked descriptions according to the ranking.

15-16. (canceled)

17. An apparatus for multiple description coding, the apparatus comprising:
at least one processor; and
at least one memory including program code; and
wherein the at least one memory and the program code are configured to, with the at least one processor, cause the apparatus at least to:
generate a plurality of descriptions using a neural network implementing a neural field, each of the plurality of descriptions comprising a respective first set of neural network parameter values obtained via training a respective instance of the neural network with a different respective subset of a set of sampled coordinate values of a multimedia object or of a larger second set of neural network parameter values corresponding to the multimedia object, wherein any two or more descriptions of the plurality of descriptions are combinable to generate a reconstruction of the multimedia object; and
direct two or more of the plurality of descriptions via an external communication link.

18. A method for multiple description coding, comprising:
receiving, from an electronic encoder, a plurality of descriptions generated using a neural network implementing a neural field, each of the plurality of descriptions comprising a respective first set of neural network parameter values obtained via training a respective instance of the neural network with a different respective subset of a set of sampled coordinate values of a multimedia object or of a larger second set of neural network parameter values corresponding to the multimedia object; and
combining, with an electronic decoder, any two or more descriptions of the plurality of descriptions to generate a combined description providing a higher quality of reconstruction of the multimedia object than any single description of the plurality of descriptions.

19-22. (canceled)

23. The method of claim 18, wherein the respective first set of neural network parameter values comprises:
a respective first subset of the larger second set of neural network parameter values at full precision; and
a respective second subset of the larger second set of neural network parameter values at less than full precision.

24. The method of claim 18, wherein each of the respective first sets of the neural network parameter values corresponds to a different respective subset of the set of sampled coordinate values of the multimedia object and a different respective sampling of the larger second set of neural network parameter values.

25. The method of claim 18, wherein the combining comprises:
for each of the two or more descriptions, generating a respective reconstructed multimedia object by inputting a full set of coordinate values into the description; and
combining the respective reconstructed multimedia objects corresponding to the two or more descriptions to generate a combined reconstructed multimedia object.

26. The method of claim 25, wherein the combining the respective reconstructed multimedia objects comprises, for each element of the combined reconstructed multimedia object, computing a respective weighted sum of corresponding elements of the respective reconstructed multimedia objects.

27. The method of claim 26,
wherein, for a first element of the combined reconstructed multimedia object, the respective weighted sum is an average of the corresponding elements of all of the respective reconstructed multimedia objects; and
wherein, for a second element of the combined reconstructed multimedia object, the respective weighted sum is an average of the corresponding elements of fewer than all of the respective reconstructed multimedia objects.

28. The method of claim 27,
wherein the first element has a coordinate value that is not present in any of the different respective subsets of the set of sampled coordinate values; and
wherein the second element has a coordinate value that is present in at least one but in fewer than all of the different respective subsets of the set of sampled coordinate values.

29. (canceled)

30. An apparatus for multiple description coding, the apparatus comprising:
at least one processor; and
at least one memory including program code; and
wherein the at least one memory and the program code are configured to, with the at least one processor, cause the apparatus at least to:
receive a plurality of descriptions generated using a neural network implementing a neural field, each of the plurality of descriptions comprising a respective first set of neural network parameter values obtained via training a respective instance of the neural network with a different respective subset of a set of sampled coordinate values of a multimedia object or of a larger second set of neural network parameter values corresponding to the multimedia object; and
combine any two or more descriptions of the plurality of descriptions to generate a combined description providing a higher quality of reconstruction of the multimedia object than any one description of the plurality of descriptions.

31-36. (canceled)
